(19) United States
(12) Patent Application Publication
(10) Pub. No.: US 2026/0199832 A1
(43) Pub. Date: Jul. 16, 2026

(54) HALOGEN DETECTION AND REMOVAL SYSTEM

(71) Applicant: BATTELLE SAVANNAH RIVER ALLIANCE, LLC, AIKEN, SC (US)

(72) Inventors: LUCAS M. ANGELETTE, MARTINEZ, GA (US); DANIEL CLAIRMONTE, NORTH AUGUSTA, SC (US); JAMES A. FOLKERT, BEECH ISLAND, SC (US); PAUL R. BEAUMONT, AIKEN, SC (US)

(21) Appl. No.: 19/019,723

(22) Filed: Jan. 14, 2025

(51) Int. Cl. B01D 53/68; B01D 53/82; B01D 53/96; G01N 21/78

(52) U.S. Cl. CPC B01D 53/685; B01D 53/82; B01D 53/96; G01N 21/783; B01D 2257/2045; B01D 2257/2047

(57) ABSTRACT

The present invention is directed to a halogen detection and removal system and a method of using the halogen detection and removal system. The halogen detection and removal system may be configured to visually indicate the presence and/or removal of a halogen or halogen-containing compound in a process stream. The halogen detection and removal system may include a container, an inorganic substrate, and a metal composition.

### FEDERAL RESEARCH STATEMENT

This invention was made with government support under Contract No. 89303321CEM000080 awarded by the U.S. Department of Energy. The government has certain rights in the invention.

### BACKGROUND OF THE INVENTION

Generally, the presence of halogens in process streams may negatively affect various aspects of a system. Notably, halogens are highly reactive and can therefore form undesirable, and even harmful, compounds. Traditionally, analytical techniques and/or wet chemistry have been used to detect the presence of halogens in process streams. Notably, these methods may have various drawbacks. For instance, analytical techniques and/or wet chemistry may use expensive equipment, complex sample preparation, and frequent and/or time-consuming calibration. Moreover, the use of analytical techniques and/or wet chemistry may expose operators to the potentially dangerous components of a system, and more particularly compounds formed at least partially from halogens.

As a result, there is a need to provide an improved halogen detection and removal system.

### SUMMARY OF THE INVENTION

Aspects and advantages of the invention will be set forth in part in the following description, or may be obvious from the description, or may be learned through practice of the invention.

In accordance with one aspect of the present invention, a halogen detection and removal system is disclosed. The halogen detection and removal system may comprise: a container; an inorganic substrate, the inorganic substrate being porous; and a metal composition, the metal composition being present on the inorganic substrate in an amount less than about 10 wt. % based on the combined weight of the inorganic substrate and the metal composition, the metal composition having a first lightness value, L₁, a first chroma value, C₁, and a first hue value, H₁; wherein, after being contacted with a halogen or a halogen-containing compound, the metal composition has a second lightness value, L₂, a second chroma value, C₂, and a second hue value, H₂; wherein after being contacted with a halogen or a halogen-containing compound, the metal composition has a negative hue difference, ΔH, the hue difference being determined by subtracting H₁ from H₂.

In accordance with another aspect of the present invention, a halogen detection and removal system is disclosed. The halogen detection and removal system may comprise: a container; an inlet process stream, the inlet process stream comprising a halogen or a halogen-containing compound; an outlet process stream; an inorganic substrate; and a metal composition, wherein when the metal composition reacts with a halogen or a halogen-containing compound in a first reaction, the first reaction forms a metal halide; wherein when the metal halide reacts with a regenerative additive in a second reaction, the second reaction forms a metal hydroxide.

In accordance with a further aspect of the present invention, a process for detecting and removing a halogen is disclosed. The process for detecting and removing a halogen may comprise: contacting a halogen or a halogen-containing compound with a metal composition, the metal composition being present on an inorganic substrate, the metal composition having a first lightness value, L₁, a first chroma value, C₁, and a first hue value, H₁; reacting the metal composition with the halogen or the halogen-containing compound, the reaction of the metal composition with the halogen or the halogen-containing compound forming a metal halide, the metal halide having a second lightness value, L₂, a second chroma value, C₂, and a second hue value, H₂; and contacting the metal halide with a regenerative additive.

### BRIEF DESCRIPTION OF THE DRAWINGS

A full and enabling disclosure of the present invention, including the best mode thereof, directed to one of ordinary skill in the art, is set forth in the specification, which makes reference to the appended figures, in which:

FIG. 1 illustrates a halogen detection and removal system in accordance with aspects of the present subject matter.

Repeat use of reference characters in the present specification and drawings is intended to represent the same or analogous features or elements of the present invention.

### DETAILED DESCRIPTION

Reference now will be made in detail to various embodiments. Each example is provided by way of explanation of the embodiments, not as a limitation of the present disclosure. In fact, it will be apparent to those skilled in the art that various modifications and variations can be made to the embodiments without departing from the scope or spirit of the present disclosure. For instance, features illustrated or described as part of one embodiment can be used with another embodiment to yield a still further embodiment. Thus, it is intended that aspects of the present disclosure cover such modifications and variations.

Generally speaking, the present invention is directed to a halogen detection and removal system and associated methods. Notably, a system formed in accordance with the present disclosure may be able to both detect the presence of a halogen and remove the halogen from an environment, such as a process stream. The halogen detection and removal system may include a container, an inorganic substrate, a metal composition, or a combination thereof. The present inventors have discovered that the halogen detection and removal system of the present disclosure can have various benefits at least partially as a result of the use of the metal composition. Particularly, the metal composition may have a first color having a first lightness value, a first chroma value, and a first hue value, and after exposure of the metal composition to one or more halogens, the metal composition may have a second color with a second lightness value, a second chroma value, and a second hue value. In this respect, the contact of a halogen with the metal composition may generally change the color of the metal composition. Notably, the halogen detection and removal system of the present disclosure may be particularly suitable in tritium production, nuclear waste processing, semiconductor component production, and other industries. It should be understood that the halogen detection and removal system of the present disclosure is generally applicable to any industry using process streams comprising halogens or halogen-containing compounds. Notably, the halogen detection and removal system may be used in separation processes.

It should be understood that throughout the entirety of this specification, each numerical value (e.g., weight percentage, concentration) disclosed should be read as modified by the term “about”, unless already expressly so modified, and then read again as not to be so modified. For instance, a value of “100” is to be understood as disclosing “100” and “about 100”. Further, it should be understood that throughout the entirety of this specification, when a numerical range (e.g., weight percentage, concentration) is described, any and every amount of the range, including the end points and all amounts therebetween, is disclosed. For instance, a range of “1 to 100”, is to be understood as disclosing both a range of “1 to 100 including all amounts therebetween” and a range of “about 1 to about 100 including all amounts therebetween”. The amounts therebetween may be separated by any incremental value. Notably, some aspects of the present invention may omit one or more of the features disclosed herein.

As previously disclosed herein, the halogen detection and removal system may include a container. Notably, the container may include an inorganic substrate and a metal composition. In general, the container may be a column, a reactor, a filter, or a cartridge. Generally, the container may have a substantially spherical configuration, a substantially cylindrical configuration, or a substantially rectangular configuration. Notably, the container may comprise a glass, stainless steel, one or more plastics, or a combination thereof. In some aspects, the container may be substantially transparent such that an operator can view the contents (e.g., inorganic substrate, metal composition) of the container from the outside of the container. A transparent container may be advantageous in that a color change of the metal composition can be visually verified by an operator without handling the container, and more generally without handling the system. Notably, the halogen detection and removal system may be replaceable. In this respect, a first halogen detection and removal system may be replaced with a second halogen detection and removal system, which may occur after the first halogen detection and removal system has been employed for a set period of time or has been exposed to a specific amount or range of halogens.

As previously disclosed herein, the halogen detection and removal system may include one or more inorganic substrates. As used herein, “inorganic substrate” refers to a substrate that does not contain carbon. Notably, an inorganic substrate may be a porous material. In some aspects, an inorganic substrate may be a mineral and/or comprise mineral components. For instance, an inorganic substrate may include a zeolite (e.g., 4A, 5A, 13X, Y), an alumina (e.g., γ-alumina), or a combination thereof. In general, one or more inorganic substrates may be in the form of pellets and/or beads.

In some aspects, an inorganic substrate may have a surface area (e.g., BET surface area) of from about 15 m²/g to about 900 m²/g, including all increments of 1 m²/g therebetween. In general, an inorganic substrate may have a surface area (e.g., BET surface area) of about 15 m²/g or more, such as about 25 m²/g or more, such as about 50 m²/g or more, such as about 75 m²/g or more, such as about 100 m²/g or more, such as about 200 m²/g or more, such as about 300 m²/g or more, such as about 400 m²/g or more, such as about 500 m²/g or more, such as about 600 m²/g or more, such as about 700 m²/g or more, such as about 800 m²/g or more. Notably, an inorganic substrate may have a surface area (e.g., BET surface area) of about 900 m²/g or less, such as about 800 m²/g or less, such as about 700 m²/g or less, such as about 600 m²/g or less, such as about 500 m²/g or less, such as about 400 m²/g or less, such as about 300 m²/g or less, such as about 200 m²/g or less, such as about 100 m²/g or less, such as about 75 m²/g or less, such as about 50 m²/g or less, such as about 25 m²/g or less.

Generally, an inorganic substrate may have an average pore size of about 0.005 nm to about 50 nm, including all increments of 0.001 nm therebetween. It should be understood that the average pore size of an inorganic substrate may be referred to as the average diameter of the pore openings of the inorganic substrate. In some aspects, an inorganic substrate may have an average pore size of about 0.005 nm or more, such as about 0.01 nm or more, such as about 0.1 nm or more, such as about 0.2 nm or more, such as about 0.4 nm or more, such as about 0.6 nm or more, such as about 0.8 nm or more, such as about 1 nm or more, such as about 2 nm or more, such as about 4 nm or more, such as about 6 nm or more, such as about 8 nm or more, such as about 10 nm or more, such as about 15 nm or more, such as about 20 nm or more, such as about 30 nm or more, such as about 40 nm or more. In general, an inorganic substrate may have an average pore size of about 50 nm or less, such as about 40 nm or less, such as about 30 nm or less, such as about 20 nm or less, such as about 10 nm or less, such as about 8 nm or less, such as about 6 nm or less, such as about 4 nm or less, such as about 2 nm or less, such as about 1 nm or less, such as about 0.8 nm or less, such as about 0.6 nm or less, such as about 0.4 nm or less, such as about 0.2 nm or less, such as about 0.1 nm or less. Notably, one or more inorganic substrates may be microporous, mesoporous, macroporous, or a combination thereof.

In some aspects, a halogen detection and removal system in accordance with the present disclosure may have a first plurality of inorganic substrates and a second plurality of inorganic substrates. Notably, the first plurality of inorganic substrates may have a different surface area and/or average pore size than the second plurality of inorganic substrates. Generally, the first plurality of inorganic substrates and/or second plurality of inorganic substrates may have any of the surface areas and/or average pore sizes as disclosed herein, including any and all ranges disclosed herein.

In general, a halogen detection and removal system in accordance with the present disclosure may include one or more metal compositions. In general, one or more metal compositions may be applied to and/or present on an inorganic substrate. Notably, one or more metal compositions may include one or more metals (i.e., elemental metals), one or more metal oxides, one or more metal hydroxides, or a combination thereof. In some aspects, a metal may be a transition metal, such as any transition metal. In some aspects, a metal may be a d-block element. In this respect, a metal may have valence electrons in d-orbitals. Notably, one or more metals may include chromium, cobalt, copper, gold, iron, magnesium, manganese, nickel, palladium, platinum, silver, tin, titanium, vanadium, zinc, zirconium, or a combination thereof. In some aspects, the one or more metal oxides may include chromium oxide, cobalt oxide, copper oxide, gold oxide, iron oxide, magnesium oxide, manganese oxide, nickel oxide, palladium oxide, platinum oxide, tin oxide, silver oxide, titanium oxide, vanadium oxide, zirconium oxide, zinc oxide, or a combination thereof. In some aspects, the one or more metal hydroxides may include chromium hydroxide, cobalt hydroxide, copper hydroxide, gold hydroxide, iron hydroxide, magnesium hydroxide, manganese hydroxide, nickel hydroxide, palladium hydroxide, platinum hydroxide, tin hydroxide, silver hydroxide, titanium hydroxide, vanadium hydroxide, zinc hydroxide, zirconium hydroxide, or a combination thereof.

Notably, a metal, a metal oxide, a metal hydroxide, or a combination thereof may contact and react with one or more halogens and/or halogen-containing compounds. For instance, a metal, a metal oxide, and/or metal hydroxide may contact and react with hydrogen fluoride and/or hydrogen chloride. Generally, when a metal reacts with a halogen-containing compound, the halogen of the compound (e.g., fluorine, chlorine) reacts with the metal to form a metal halide. Further, when a metal oxide reacts with a halogen-containing compound, the halogen of the compound (e.g., fluorine, chlorine) may react with the metal to form a metal halide and the oxygen may react with the remainder of the compound previously containing a halogen. For instance, if the compound contains hydrogen and a halogen, the halogen of the compound may react with the metal to form a metal halide and the oxygen may react with hydrogen to form water. Additionally, when a metal hydroxide reacts with a halogen-containing compound, the halogen of the compound (e.g., fluorine, chlorine) may react with the metal to form a metal halide and the hydroxide may react with the remainder of the compound previously containing a halogen. For instance, if the compound contains hydrogen and a halogen, the halogen of the compound may react with the metal to form a metal halide and the hydroxide may react with hydrogen to form water.

In general, a metal composition may be converted into a metal halide after a halogen or a halogen-containing compound contacts and reacts with the metal composition. It should be understood that a metal composition may transition or change from a metal, a metal oxide, or a metal hydroxide to a metal halide after reacting with a halogen or a halogen-containing compound.

Generally, a metal composition may comprise one or more metals, one or more metal oxides, one or more metal hydroxides, or a combination thereof in an amount from about 50 wt. % to about 100 wt. %, including all increments of 1 wt. % therebetween. For instance, a metal composition may comprise one or more metals, one or more metal oxides, one or more metal hydroxides, or a combination thereof in an amount of about 50 wt. % or more, such as about 60 wt. % or more, such as about 70 wt. % or more, such as about 80 wt. % or more, such as about 90 wt. % or more, such as about 95 wt. % or more, such as about 98 wt. % or more. In general, a metal composition may comprise one or more metals, one or more metal oxides, one or more metal hydroxides, or a combination thereof in an amount of about 100 wt. % or less, such as about 98 wt. % or less, such as about 95 wt. % or less, such as about 90 wt. % or less, such as about 80 wt. % or less, such as about 70 wt. % or less, such as about 60 wt. % or less.

In some aspects, one or more metal salts may be applied to an inorganic substrate to form a metal composition. In this respect, a metal salt may be applied to an inorganic substrate. Then, the metal of the metal salt may be adsorbed by the inorganic substrate to form a metal composition. Next, the inorganic substrate having a metal composition present thereon may be dried. The one or more metal salts may include a chromium salt, a cobalt salt, a copper salt, a gold salt, an iron salt, a magnesium salt, a manganese salt, a nickel salt, a palladium salt, a platinum salt (e.g., H₂PtCl₆, PtCl₄), a silver salt, a titanium salt, a vanadium salt, a zinc salt, a zirconium salt, or a combination thereof.

Notably, one or more metal salts may be applied to an inorganic substrate by various methods. For instance, in one aspect, a metal salt may be sprayed on an inorganic substrate. In this respect, a metal salt may be combined with an aqueous composition (e.g., water) to form a metal salt solution that is sprayed on an inorganic substrate. Notably, a metal salt solution may comprise one or more metal salts and an aqueous composition. In general, a sprayer or nebulizer may be utilized to spray a metal salt solution on an inorganic substrate. A sprayer or nebulizer may generate droplets and/or a mist of the metal salt solution that is applied to an inorganic substrate. In another aspect, an inorganic substrate may be dip-coated in a metal salt solution. In this respect, an aqueous composition may be combined with a metal salt in a container to form a metal salt solution. Then, an inorganic substrate may be dipped into the metal salt solution such that at least a portion of the surface of the inorganic substrate contacts the metal salt solution such that a metal salt and/or a portion of the metal salt solution adheres and/or is retained on the portion of the inorganic substrate that contacts the metal salt solution. In yet another aspect, the inorganic substrate may be spin-coated in a metal salt solution. In this respect, a selectively chosen amount of a metal salt solution is deposited on the inorganic substrate. Then, the inorganic substrate may be spun at high speed to spread the metal salt solution over at least a portion of the surface of the inorganic substrate. In yet a further aspect, a metal salt solution may be applied to an inorganic substrate via printing, such as inkjet printing and/or microprinting. In this respect, in one aspect, a metal salt and/or a metal salt solution may be loaded into an inkjet cartridge. Then, droplets of the metal salt and/or the metal salt solution may be applied to the surface of the inorganic substrate via an inkjet printer. In another aspect, when microprinting is utilized, a stamp and/or mold may be coated with a metal salt and/or a metal salt solution. Next, the stamp and/or mold may be pressed against a surface of the inorganic substrate to impart and/or transfer the metal salt and/or a metal salt solution to the inorganic substrate. Notably, inkjet printing and microprinting may allow for the application of a metal salt and/or a metal salt solution in a selectively chosen pattern and/or shape to an inorganic substrate. Further, inkjet printing and microprinting may allow for the application of a metal salt and/or a metal salt solution over a selectively chosen surface area of an inorganic substrate. In yet another further aspect, a metal salt solution containing a metal salt may be applied to an inorganic substrate via a pipette or dropper.

In some aspects, a metal salt may be applied to an inorganic substrate via wetness impregnation, such as incipient wetness impregnation.

In some aspects, a metal composition and/or a metal salt may be applied to and/or present on an inorganic substrate in an amount of about 0.001 wt. % or more based on the combined weight of the metal composition and/or the metal salt and the inorganic substrate, such as about 0.01 wt. % or more, such as about 0.1 wt. % or more, such as about 0.2 wt. % or more, such as about 0.5 wt. % or more, such as about 0.8 wt. % or more, such as about 1 wt. % or more, such as about 1.5 wt. % or more, such as about 2 wt. % or more, such as about 2.5 wt. % or more, such as about 3 wt. % or more, such as about 3.5 wt. % or more, such as about 4 wt. % or more, such as about 4.5 wt. % or more, such as about 5 wt. % or more, such as about 6 wt. % or more, such as about 7 wt. % or more, such as about 8 wt. % or more, such as about 9 wt. % or more. In general, a metal composition and/or a metal salt may be applied to and/or present on an inorganic substrate in an amount of about 10 wt. % or less based on the combined weight of the metal composition and/or the metal salt and the inorganic substrate, such as about 9 wt. % or less, such as about 8 wt. % or less, such as about 7 wt. % or less, such as about 6 wt. % or less, such as about 5 wt. % or less, such as about 4.5 wt. % or less, such as about 4 wt. % or less, such as about 3.5 wt. % or less, such as about 3 wt. % or less, such as about 2.5 wt. % or less, such as about 2 wt. % or less, such as about 1.5 wt. % or less, such as about 1 wt. % or less, such as about 0.8 wt. % or less, such as about 0.5 wt. % or less, such as about 0.2 wt. % or less, such as about 0.1 wt. % or less. In some aspects, the aforementioned values may refer to volume percent. In this respect, a metal composition and/or a metal salt may be applied to and/or present on an inorganic substrate in an amount of about 0.001% to about 10%, including all increments of 0.001% therebetween, based on the combined volume of the metal composition and/or the metal salt and the inorganic substrate.

Notably, the amount of a metal composition applied to and/or present on an inorganic substrate based on the combined weight of the metal composition and the inorganic substrate is preferably less than 10 wt. %. Notably, the inventors of the present disclosure have found that when a metal composition is applied to and/or present on an inorganic substrate in an amount over 10 wt. % based on the combined weight of the metal composition and the inorganic substrate, the metal composition may begin to clump. Such clumping may result in decreased flow efficiency, irregular flow paths, decreased metal dispersion, and/or shortened column or system life. With respect to decreased metal dispersion and column life, such clumping may negatively affect the life of the column because clumping may result in significant portions of the metal composition being inaccessible, or, in other words, particles of the metal composition may be covered by other particles of the metal composition leading to portions of the metal composition being unable to contact a halogen or halogen-containing compound.

Similarly, the amount of a metal salt applied to an inorganic substrate based on the combined weight of the metal salt and the inorganic substrate is preferably less than 10 wt. %. Notably, the inventors of the present disclosure have found that when a metal salt is applied to an inorganic substrate in an amount over 10 wt. % to form a metal composition, the metal composition formed by the metal salt may have a decreased metal dispersion as compared to the metal dispersion of a metal composition that was formed by a metal salt being applied to an inorganic substrate in a lesser amount.

Generally, a metal composition may be present on the surface of an inorganic substrate in an amount of about 50% or less of the surface area (e.g., BET surface area) of the inorganic substrate, such as about 40% or less, such as about 30% or less, such as about 20% or less, such as about 10% or less, such as about 5% or less, such as about 1% or less. In one aspect, a metal composition may be present on the surface of an inorganic substrate in an amount of about 0.05% or more of the surface area (e.g., BET surface area) of the inorganic substrate, such as about 0.1% or more, such as about 1% or more, such as about 5% or more, such as about 10% or more, such as about 20% or more, such as about 30% or more, such as about 40% or more. Notably, having a portion of the surface of the inorganic substrate not comprising a metal composition may be beneficial in that products resulting from the reaction of the metal composition and a halogen-containing compound may be adsorbed by the inorganic substrate. For instance, when a metal oxide reacts with a compound containing hydrogen and a halogen, the halogen of the compound reacts with the metal to form a metal halide and the oxygen reacts with hydrogen to form water. The water may be adsorbed by the inorganic substrate, which may prevent the water from reacting with other process stream compounds and/or may aid in the corrosion resistance of the system.

In some aspects, at least a portion of the surface area of an inorganic substrate may not have a coating or, in other words, may be bare. Generally, an inorganic substrate may not have a coating on 99% or less of the surface area (e.g., BET surface area) of the inorganic substrate, such as about 95% or less, such as about 90% or less, such as about 80% or less, such as about 70% or less, such as about 60% or less, such as about 50% or less, such as about 40% or less, such as about 30% or less, such as about 20% or less, such as about 10% or less. In general, an inorganic substrate may not have a coating on 1% or more of the surface area (e.g., BET surface area) of the inorganic substrate, such as about 5% or more, such as about 10% or more, such as about 20% or more, such as about 30% or more, such as about 40% or more, such as about 50% or more, such as about 60% or more, such as about 70% or more, such as about 80% or more, such as about 90% or more, such as about 95% or more.

As previously disclosed herein, in some aspects, a halogen detection and removal system in accordance with the present disclosure may have a first plurality of inorganic substrates and a second plurality of inorganic substrates. Notably, the first plurality of inorganic substrates may have a metal composition applied to and/or present on an inorganic substrate in a weight percentage or volume percentage that is different from the second plurality of inorganic substrates. In some aspects, the first plurality of inorganic substrates may have a metal composition present on the surface of an inorganic substrate in an amount covering a surface area that is different from the second plurality of inorganic substrates. In some aspects, the first plurality of inorganic substrates may be more or less bare on the surface of an inorganic substrate as determined by surface area as compared to the second plurality of inorganic substrates.

Generally, the first plurality of inorganic substrates and/or second plurality of inorganic substrates may have any of the amounts (e.g., weight percent, volume percent) of a metal composition applied to and/or present on the respective inorganic substrates disclosed herein, any of the amounts of a metal composition present on the surface of the inorganic substrates as determined by surface area as disclosed herein, and/or any of the amounts of bare inorganic substrate surface as determined by surface area as previously disclosed herein.

In general, the metal composition may have a first color having a first lightness value, a first chroma value, and a first hue value. When contacted with a process stream comprising a halogen, such as a gas stream comprising hydrogen fluoride and/or hydrogen chloride, the metal composition may change to a second color. The second color may have a second lightness value, a second chroma value, and a second hue, any or all of which may be different from the first lightness value, the first chroma value, and the first hue value. Notably, such a change in lightness, chroma, and/or hue, and more generally color, may be indicative of the presence and/or removal of one or more halogens in a process stream.

The difference in the light, chroma, or hue may be referred to as ΔL (i.e., L₂-L₁), ΔC (i.e., C₂-C₁), and ΔH (i.e., H₂-H₁) respectively. It should be understood that subscript “2” refers to the respective value after the metal composition is contacted with a halogen or a halogen-containing compound and that the subscript “1” refers to the respective value before the metal composition is contacted with a halogen or a halogen-containing compound. In this respect, the L₂, C₂, and H₂ values refer to the second lightness, the second chroma, and the second hue values respectively. Further, the L₁, C₁, and H₁ values refer to the first lightness, the first chroma, and the first hue values respectively. Notably, the light, chroma, or hue values of the present disclosure may be determined via CIELAB 1976 color space or RGB color model. The RGB color model may be converted into HSL color space or HSV color space. In this respect, the light, chroma, or hue values of the present disclosure may be determined via the HSL color space or the HSV color space.

In general, the ΔL, ΔC, and/or ΔH values may be positive, negative, or a combination thereof. When the ΔL, ΔC, and ΔH values are positive, the metal composition may be said to have a positive lightness difference, a positive chroma difference, and/or a positive hue difference respectively. When the ΔL, ΔC, and ΔH values are negative, the metal composition may be said to have a negative lightness difference, a negative chroma difference, and/or a negative hue difference respectively.

In some aspects, the first color of the metal composition and/or the second color of the metal composition may have a wavelength from about 350 nm to about 750 nm, including all increments of 1 nm therebetween. For instance, the first color and/or the second color may have a wavelength of about 350 nm or more, such as about 400 nm or more, such as about 500 nm or more, such as about 600 nm or more, such as about 700 nm or more. In general, the first color and/or the second color may have a wavelength of about 750 nm or less, such as about 600 nm or less, such as about 500 nm or less, such as about 400 nm or less.

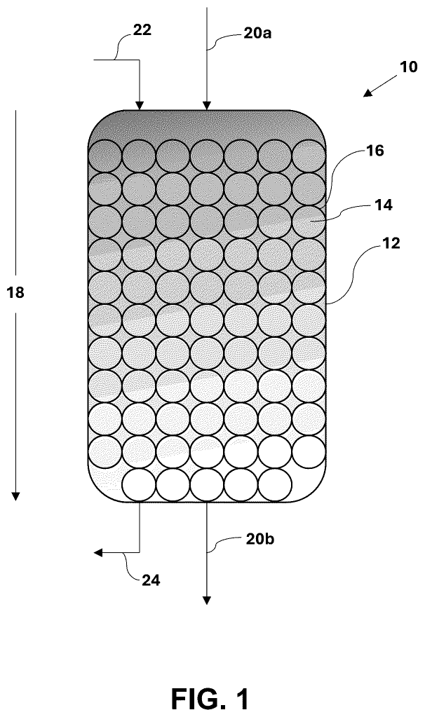

Notably, a container containing an inorganic substrate having a metal composition present thereon may exhibit a color gradient after the metal composition reacts with a halogen or a halogen-containing compound. In this respect, an inorganic substrate or a plurality of inorganic substrates having a metal composition present thereon may exhibit a color gradient across the inorganic substrate or the plurality of inorganic substrates after the metal composition reacts with a halogen or a halogen-containing compound. Referring to FIG. 1, FIG. 1 illustrates a halogen detection and removal system 10 comprising a container 12 containing a plurality of inorganic substrates 14 having a metal composition 16 present thereon. The system 10 further comprises an inlet process stream 20a and an outlet process stream 20b. The reference numeral 18 is indicative of a process stream flow (e.g., gas stream flow) containing a halogen or a halogen-containing compound moving or flowing in the direction 18. As illustrated in FIG. 1, the reaction of a metal composition 16 with a halogen may result in a color gradient forming across a dimension of the halogen detection and removal system 10, and more particularly forming across the plurality of inorganic substrates 14 having a metal composition 16 present thereon. FIG. 1 further illustrates a regenerative additive inlet stream 22 and a regenerative additive outlet stream 24. In general, a regenerative additive inlet stream 22 and/or a regenerative additive outlet stream 24 may comprise a regenerative additive. Notably, a regenerative additive may be contacted with and/or reacted with a metal halide to restore the metal halide to a metal, a metal oxide, or a metal hydroxide such that it can react with a halogen and/or a halogen-containing compound any number of times.

Notably, the halogen detection and removal system of the present disclosure may be regenerated. For instance, after a metal composition has reacted with a halogen and/or a halogen-containing compound to form a metal halide, a regenerative additive may be contacted with and/or reacted with the metal halide to restore the metal composition to a metal, a metal oxide, or a metal hydroxide such that it can react with a halogen and/or a halogen-containing compound any number of times. In this respect, it should be understood that a metal composition may transition or change from a metal halide to a metal, a metal oxide, or a metal hydroxide after reacting with a regenerative additive. As used herein, a “regenerative additive” refers to an additive that converts a metal halide to a metal, a metal oxide, or a metal hydroxide. In general, the regenerative additive may be a liquid or a dispersion, which can be referred to as a liquid containing solid components. In one aspect, the restoration of the metal halide to a metal, a metal oxide, or a metal hydroxide may change the color of the metal composition from a second color back to the original first color and/or first lightness value, first chroma value, and/or first hue value. In one aspect, the restoration of the metal halide to a metal, a metal oxide, or a metal hydroxide may change the color of the metal composition from a second color to a third color. The third color may have a third lightness value, a third chroma value, and a third hue value that are the same or different from the second lightness, the second chroma, and the second hue values respectively. Then, a halogen or a halogen-containing compound may be contacted and reacted with the metal composition such that the metal composition changes from a third color to a fourth color. The third color may have a third lightness value, a third chroma value, and a third hue value that are the same or different from the fourth lightness, the fourth chroma, and the fourth hue values respectively. It should be understood that the process of restoration of the metal composition may be completed any number of times and may result in the metal composition having any number of colors having respective lightness, chroma, and/or hue values.

In some aspects, water and/or steam may be used as a regenerative additive to regenerate a metal halide. In this respect, in one aspect, water and/or steam may be contacted with a metal halide to form a metal hydroxide. In general, when a regenerative additive, such as water or steam, and a metal halide react, the products may be a metal hydroxide and one or more halogen-containing compounds (e.g., hydrogen fluoride, hydrogen chloride). In this respect, a regenerative additive may react with a metal halide to form a metal hydroxide, which may allow the halogen detection and removal system to be used repeatedly. In general, the formation of a metal, a metal oxide, or a metal hydroxide from a metal halide may allow for at least a second use of the halogen detection and removal system. Notably, a regenerative additive may extract one or more halogens and/or halogen-containing compounds from a halogen detection and removal system and remove the one or more halogens and/or halogen-containing compounds from the system. For instance, water may extract one or more halogens and/or halogen-containing compounds from a halogen detection and removal system via the reaction of the water with a metal halide and may carry or transport the one or more halogens and/or halogen-containing compounds out of the system such that the one or more halogens are removed from the system.

In some aspects, to remove a regenerative additive from a halogen detection and removal system, a gas (e.g., pressurized gas) may be placed in an inlet of the container and the gas may flow and remove at least a portion of the regenerative additive from the container. Notably, the gas used to remove a regenerative additive from a halogen detection and removal system may be a humid gas, which may be referred to as wet gas, or air. In some aspects, the container may be heated to remove the regenerative additive from the system. In this respect, a halogen detection and removal system may be heated such that the regenerative additive vaporizes and is removed from the system. In some aspects, the container may be heated and a gas may flow through the container and remove at least a portion of the regenerative additive from the container.

### EXAMPLES

Various metal salts were applied to an inorganic substrate via wet impregnation using a solution of water and a metal salt. The solution uptake percentage of the respective samples and the metal dispersion of the respective samples were measured.

The solution uptake percentage refers to the percentage of a solution adsorbed by an inorganic substrate during impregnation. For instance, if 25 mL of a 1 wt. % solution of water and a metal salt is used to impregnate an inorganic substrate, and 5 mL of the solution remains after impregnation (i.e., is not adsorbed by the inorganic substrate), the solution uptake percentage would be 80%. The equation to determine the solution uptake percentage is as follows:

$$Solution Uptake Percentage = ( \frac{Initial Volume of Solution - Final Volume of Solution}{Inital Volume of Solution} ) * 100 \%$$

The metal dispersion was determined via chemisorption measured by a Micromeritics ASAP2020. Notably, the process begins with surface preparation of an inorganic substrate already having the metal salt applied thereto, where the inorganic substrate is heated in a hydrogen atmosphere to reduce the surface, effectively cleaning it and activating the metal sites for adsorption. Next, an initial adsorption isotherm is measured using ultra-high-purity air to capture the baseline adsorption behavior of the prepared surface. This is followed by a second adsorption isotherm under identical conditions. The difference between the two isotherms is then analyzed using mathematical models to calculate the amount of accessible metal on the surface. After this value is obtained, the value is divided by the total metal content, which was input by the operator. The metal dispersion refers to how uniformly the metal is distributed over the surface of the inorganic substrate.

Notably, the four metal salts utilized in Table 1 are H₂PtCl₆, PtCl₄, H₂PtCl₆/SnCl₂, and PtCl₄/SnCl₂. The inorganic substrate utilized in Table 1 is CBV-100, which is a zeolite made by Zeolyst International.

TABLE 1

| | | | | | | Ratio of |
|---|---|---|---|---|---|---|
| | | | Target | | | Metal |
| | | | Metal | Solution | Metal | Dispersion/ |
| Sample | Inorganic | | Loading | Uptake | Dispersion | Solution |
| Number | Substrate | Metal Salt | [%] | [%] | [%] | Uptake |
| 1 | CBV-100 | PtCl₄/SnCl₂ | 1 | 1.09 | 65.5574 | 60.14440367 |
| 2 | CBV-100 | PtCl₄ | 1 | 0.71 | 95.2298 | 134.1264789 |
| 3 | CBV-100 | PtCl₄ | 1.5 | 1.35 | 66.2725 | 49.09074074 |
| 4 | CBV-100 | H₂PtCl₆/SnCl₂ | 1 | 1.07 | 57.9663 | 54.17411215 |
| 5 | CBV-100 | H₂PtCl₆/SnCl₂ | 1 | 0.8119 | 41.5816 | 51.21517428 |
| 6 | CBV-100 | H₂PtCl₆/SnCl₂ | 1 | 0.813 | 43.5281 | 53.5400984 |
| 7 | CBV-100 | H₂PtCl₆/SnCl₂ | 1 | 0.7988 | 41.2494 | 51.63920881 |
| 8 | CBV-100 | H₂PtCl₆/SnCl₂ | 1 | 0.9518 | 46.968 | 49.34650137 |
| 9 | CBV-100 | H₂PtCl₆/SnCl₂ | 1 | 0.853 | 45.0381 | 52.7996483 |
| 10 | CBV-100 | H₂PtCl₆/SnCl₂ | 1 | 1.0462 | 40.2461 | 38.46883961 |
| 11 | CBV-100 | H₂PtCl₆/SnCl₂ | 1 | 1.0014 | 39.0194 | 38.96484921 |
| 12 | CBV-100 | H₂PtCl₆ | 0.25 | 0.2129 | 85.8116 | 403.0605918 |
| 13 | CBV-100 | H₂PtCl₆ | 0.25 | 0.2111 | 62.9737 | 298.3121743 |
| 14 | CBV-100 | H₂PtCl₆ | 0.5 | 0.4737 | 79.6398 | 168.1228626 |
| 15 | CBV-100 | H₂PtCl₆ | 0.5 | 0.425 | 97.257 | 228.84 |
| 16 | CBV-100 | H₂PtCl₆ | 0.5 | 0.4458 | 49.0676 | 110.0663975 |
| 17 | CBV-100 | H₂PtCl₆ | 1 | 0.74 | 69.3536 | 93.72108108 |
| 18 | CBV-100 | H₂PtCl₆ | 1 | 0.8398 | 70.7918 | 84.29602286 |
| 19 | CBV-100 | H₂PtCl₆ | 1 | 0.9307 | 83.0166 | 89.19802299 |
| 20 | CBV-100 | H₂PtCl₆ | 2 | 1.7919 | 70.2579 | 39.20860539 |
| 21 | CBV-100 | H₂PtCl₆ | 2 | 1.6041 | 63.6038 | 39.6507699 |

While particular embodiments of the present disclosure have been illustrated and described, it would be obvious to those skilled in the art that various other changes and modifications can be made without departing from the spirit and scope of the present disclosure. It is therefore intended to cover in the appended claims all such changes and modifications that are within the scope of this disclosure.

1. A halogen detection and removal system comprising:
a container;
an inorganic substrate, the inorganic substrate being porous; and
a metal composition, the metal composition being present on the inorganic substrate in an amount less than about 10 wt. % based on the combined weight of the inorganic substrate and the metal composition, the metal composition having a first lightness value, L₁, a first chroma value, C₁, and a first hue value, H₁;
wherein, after being contacted with a halogen or a halogen-containing compound, the metal composition has a second lightness value, L₂, a second chroma value, C₂, and a second hue value, H₂;
wherein after being contacted with a halogen or a halogen-containing compound, the metal composition has a negative hue difference, ΔH, the hue difference being determined by subtracting H₁ from H₂.

2. The halogen detection and removal system of claim 1, wherein the metal composition is present on the inorganic substrate in an amount less than about 5 wt. % based on the combined weight of the inorganic substrate and the metal composition.

3. The halogen detection and removal system of claim 1, wherein the inorganic substrate has an average pore size of about 50 nm or less.

4. The halogen detection and removal system of claim 1, wherein the metal composition comprises a metal in an amount of about 50 wt. % or more.

5. The halogen detection and removal system of claim 1, wherein the metal composition is a metal that has valence electrons in d-orbitals.

6. The halogen detection and removal system of claim 1, wherein the metal composition comprises copper, cobalt, silver, or a combination thereof.

7. The halogen detection and removal system of claim 1, wherein when the metal composition reacts with a halogen or a halogen-containing compound, the reaction forms a metal halide.

8. The halogen detection and removal system of claim 1, wherein at least a portion of the inorganic substrate does not include a coating.

9. The halogen detection and removal system of claim 1, wherein the inorganic substrate is a zeolite.

10. The halogen detection and removal system of claim 1, wherein the inorganic substrate is an alumina.

11. The halogen detection and removal system of claim 10, wherein the inorganic substrate is γ-alumina.

12. The halogen detection and removal system of claim 1, wherein the second lightness value, L₂, is different from the first lightness value, L₁.

13. The halogen detection and removal system of claim 1, wherein the second chroma value, C₂, is different from the first chroma value, C₁.

14. The halogen detection and removal system of claim 1, wherein the halogen detection and removal system comprises a plurality of inorganic substrates having the metal composition present thereon, wherein, after being contacted with a halogen or a halogen-containing compound, the plurality of inorganic substrates having the metal composition present thereon have a color gradient.

15. A halogen detection and removal system comprising:
a container;
an inlet process stream, the inlet process stream comprising a halogen or a halogen-containing compound;
an outlet process stream;
an inorganic substrate; and
a metal composition, wherein when the metal composition reacts with a halogen or a halogen-containing compound in a first reaction, the first reaction forms a metal halide;
wherein when the metal halide reacts with a regenerative additive in a second reaction, the second reaction forms a metal hydroxide.

16. The halogen detection and removal system of claim 15, wherein the regenerative additive comprises water.

17. The halogen detection and removal system of claim 15, wherein the regenerative additive comprises wet gas.

18. The halogen detection and removal system of claim 15, wherein the metal composition is present on the inorganic substrate in an amount less than about 10 wt. % based on the combined weight of the inorganic substrate and the metal composition.

19. A process for detecting and removing a halogen comprising:
contacting a halogen or a halogen-containing compound with a metal composition, the metal composition being present on an inorganic substrate, the metal composition having a first lightness value, L₁, a first chroma value, C₁, and a first hue value, H₁;
reacting the metal composition with the halogen or the halogen-containing compound, the reaction of the metal composition with the halogen or the halogen-containing compound forming a metal halide, the metal halide having a second lightness value, L₂, a second chroma value, C₂, and a second hue value, H₂; and
contacting the metal halide with a regenerative additive.

20. The process for detecting and removing a halogen of claim 19, wherein the process further includes a step of reacting the metal halide with the regenerative additive to form a metal hydroxide.
